(19) United States
(12) Patent Application Publication
(10) Pub. No.: US 2023/0066430 A1
(43) Pub. Date: Mar. 2, 2023

(54) Stripper-Crimper Ferrule Reel Mount

(71) Applicant: Hoffman Enclosures Inc., Anoka, MN (US)

(72) Inventors: Florian Hillen, Aachen (DE); Norbert Röhrig, Escheriler (DE)

(21) Appl. No.: 17/902,126

(22) Filed: Sep. 2, 2022

Related U.S. Application Data
(60) Provisional application No. 63/240,283, filed on Sep. 2, 2021.

(51) Int. Cl. H01R 43/055; B65H 49/20

(52) U.S. Cl. CPC H01R 43/055; B65H 49/20; H01R 43/05

(57) ABSTRACT

The present disclosure provides a ferrule support assembly for a stripper-crimper machine and other similar devices. The ferrule support assembly can include an axle configured to be received within a drum of a ferrule reel, a first support plate configured to be coupled to the stripper-crimper machine, and a second support plate opposite the first support plate. The first support plate and the second support plate can include an axle notch configured to engage the axle extending between the first and second support plates.

### RELATED APPLICATIONS

The present application is based on and claims priority to U.S. Provisional Patent Application No. 63/240,283, filed Sep. 2, 2021, and entitled “Stripper-Crimper Ferrule Reel Mount”, which is incorporated herein by reference in its entirety.

### BACKGROUND

Stripper-crimper machines can be used for processing one or more wire end ferrules on ferrule reels (i.e., spools). The ferrule reels include a roll of interconnected wire end ferrules. The roll of wire end ferrules are wrapped around a drum of the ferrule reel between a set of reel flanges, typically made of cardboard.

### SUMMARY

According to one aspect of the present disclosure, a ferrule reel mount for supporting a plurality of ferrule reels on a stripper-crimper machine is provided. The ferrule reel mount comprises a plurality of ferrule reels, a plurality of support plates supported by a stripper-crimper machine, and a plurality of axles that support the ferrule reels relative to the support plates, including an axle spanning between each set of adjacent support plates of the plurality of support plates. The axle is received within a drum of a ferrule reel of the plurality of ferrule reels to support the ferrule reel between the adjacent support plates. The ferrule reel and an adjacent ferrule reel among the plurality of ferrule reels are supported by a common one of the support plates.

In some aspects, relative to an axial direction of an axle, an axial clearance between a reel flange extending radially outward from a drum of a ferrule reel of a plurality of ferrule reels and an adjacent support plate is between about 1 mm and about 12 mm.

In some aspects, relative to an axial direction of an axle, support plates of each set of adjacent support plates are axially separated by a gap of greater than or equal to 22 mm.

In some aspects, a set of adjacent support plates includes a first support plate supported by a stripper-crimper machine, and a second support plate supported by the stripper-crimper machine, and on an opposite side of a ferrule reel from the first support plate. Each of the first support plate and the second support plate includes an axle notch configured to engage an axle extending between the first and second support plates.

In some aspects, a ferrule reel mount comprises a first spacer coupled to a first support plate on a side of the first support plate that faces a second support plate, and a second spacer coupled to the second support plate on a side of the second support plate that faces the first support plate. Each of the first and second spacers includes a notch aligned with an axle notch of the first and second support plates, respectively. Each of the notches in the first and second spacers defines a notch profile that matches a profile of the axle notch in the corresponding first or second support plate.

In some aspects, an axle notch defines an axle notch profile that includes a guide portion and a base portion. The guide portion includes a first angled edge and a second angled edge arranged to guide the axle into the base portion of the axle notch. The base portion includes a u-shaped slot connecting the first and second angled edges.

In some aspects, an axle defines an axial length that is greater than a width of a drum of a ferrule reel.

In some aspects, an axle includes an axle shaft and axle protrusions extending from opposing ends of the axle shaft. The axle shaft defines a first diameter configured to be received within a drum of a corresponding ferrule reel, and the axle protrusions define a second diameter that is smaller than the first diameter.

According to one aspect, a ferrule support assembly for a stripper-crimper machine is provided. The ferrule support assembly comprises an axle configured to be received within a drum of a ferrule reel, a first support plate configured to be coupled to the stripper-crimper machine, and a second support plate configured to be coupled to the stripper-crimper machine, and spaced apart from the first support plate. The first support plate and the second support plate include an axle notch that receives and supports the axle, with the axle extending between the first and second support plates, for rotatable support of the drum via the axle.

In some aspects, a ferrule support assembly comprises a first spacer coupled to a first support plate facing a second support plate, and a second spacer coupled to the second support plate facing the first support plate.

In some aspects, each of first and second spacers include a notch aligned with an axle notch of a first and second support plate, respectively. Each of the notches in the first and second spacers define a notch profile that is substantially identical to a profile of the axle notch in the corresponding first or second support plate.

In some aspects, an axle notch defines an axle notch profile that includes a guide portion and a base portion. The guide portion includes a first angled edge and a second angled edge configured to guide an axle into the base portion of the axle notch. The base portion includes a u-shaped slot with side walls that extend from the first and second angled edges.

In some aspects, first and second support plates are axially separated by a gap, the gap defining a width of greater than or equal to 22 mm, to receive the drum of the ferrule reel for rotational support via the axle.

In some aspects, an axle defines an axial length that is greater than a width of a drum of a ferrule reel.

In some aspects, a ferrule support assembly comprises a curved support plate configured to be coupled to a stripper-crimper machine and extend from the stripper-crimper machine to at least partially surround a peripheral edge of a ferrule reel.

In some aspects, an axle includes an axle shaft having axle protrusions extending from opposing ends of the axle shaft. The axle shaft defines a first diameter configured to be received within a drum of a ferrule reel, and the axle protrusions define a second, smaller diameter configured to be received within an axle notch of first and second support plates.

In some aspects, a ferrule support assembly comprises a plurality of support sub-assemblies, including a first support sub-assembly and one or more second support sub-assemblies. The first support sub-assembly includes an axle, a first support plate, and a second support plate. Each of the one or more second support sub-assemblies includes, respectively, a sub-assembly axle, a sub-assembly first support plate, and a sub-assembly second support plate that are substantially identical to the axle, the first support plate, and the second support plate, respectively. The support sub-assemblies are configured to be secured to a stripper-crimper machine to support a plurality of ferrule reels.

In some aspects, for a first support sub-assembly and an adjacent support sub-assembly of one or more second support sub-assemblies share a common support plate that forms one of a first support plate or a second support plate and one of a sub-assembly first support plate or a sub-assembly second support plate.

In some aspects, axially outermost support plates of a plurality of support sub-assemblies include one or more side edges that are bent away from a ferrule reel supported by a corresponding sub-assembly.

According to one aspect, a method of retrofitting a ferrule reel support assembly on a stripper-crimper machine is provided. The method comprises removing an installed first ferrule reel support assembly from a support surface of a housing of the stripper-crimper machine, and installing a second ferrule reel support assembly onto the support surface of the stripper-crimper machine. The second ferrule reel support assembly includes an axle configured to be received within a drum of a ferrule reel, a first support plate configured to be coupled to the stripper-crimper machine, and a second support plate configured to be coupled to the stripper-crimper machine opposite the ferrule reel from the first support plate. The first support plate and the second support plate include an axle notch configured to receive and support the axle, with the axle extending between the first and second support plates, to rotatably support the drum via the axle.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 is a first isometric view of a stripper-crimper including a ferrule reel mount assembly according to one aspect of the disclosure;

FIG. 2 is a second isometric view of the stripper-crimper of FIG. 1;

FIG. 3 is a side view of the stripper-crimper of FIG. 1;

FIG. 4 is an exploded view of a ferrule reel support assembly according to one aspect of the present disclosure;

FIG. 5 is a detail view of a reel notch of the ferrule reel support assembly of FIG. 4;

FIG. 6 is a cross-section view of the stripper-crimper of FIG. 1 taken along line 6-6 (see FIG. 3);

FIG. 7 is an isometric view of a stripper-crimper including a ferrule reel mount assembly having a curved backing plate according to one aspect of the disclosure;

FIG. 8 is a rear view of the stripper-crimper of FIG. 7;

FIG. 9 is a perspective view of the stripper-crimper of FIG. 7; and

FIG. 10 illustrates a method of retrofitting a stripper-crimper with the ferrule reel mount assembly of FIG. 1.

### DETAILED DESCRIPTION

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

As used herein, unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings. As also used herein, unless specified or limited otherwise, the terms “about”, “approximately”, and “substantially” and variations thereof, when used relative to a numerical value, define a range of values within 20% of the numerical value (e.g., within 15%, 10%, or within 5%).

As used herein, unless otherwise limited or specified, “substantially identical” refers to two or more components or systems that are manufactured or used according to the same process and specification, with variation between the components or systems that are within the limitations of acceptable tolerances for the relevant process and specification. For example, two components can be considered to be substantially identical if the components are manufactured according to the same standardized manufacturing steps, with the same materials, and within the same acceptable dimensional tolerances (e.g., as specified for a particular process or product).

In some implementations, devices or systems disclosed herein can be utilized, manufactured, or installed using methods embodying aspects of the invention. Correspondingly, any description herein of particular features, capabilities, or intended purposes of a device or system is generally intended to include disclosure of a method of using such devices for the intended purposes, of a method of otherwise implementing such capabilities, of a method of manufacturing relevant components of such a device or system (or the device or system as a whole), and of a method of installing disclosed (or otherwise known) components to support such purposes or capabilities. Similarly, unless otherwise indicated or limited, discussion herein of any method of manufacturing or using for a particular device or system, including installing the device or system, is intended to inherently include disclosure, as embodiments of the invention, of the utilized features and implemented capabilities of such device or system.

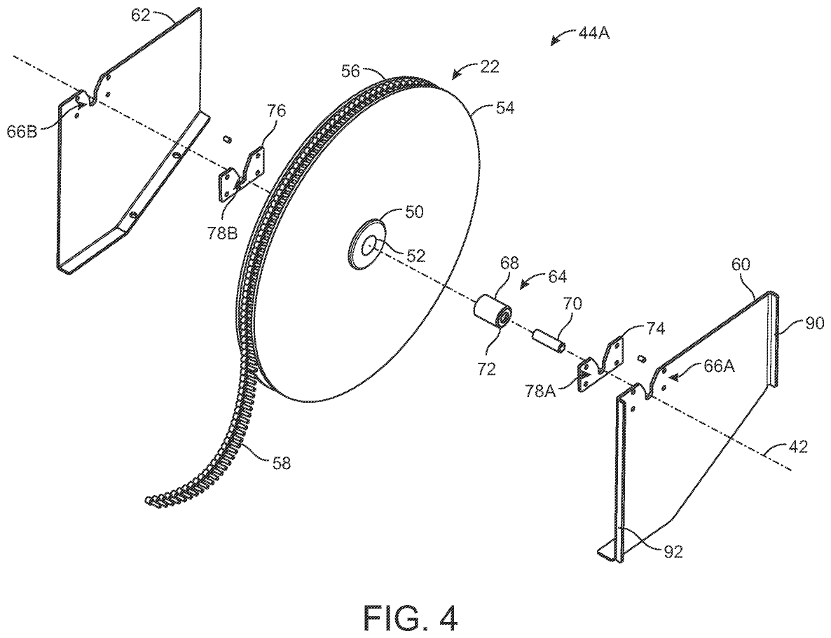

Stripper-crimper machines can support one or more ferrule reels (i.e., spools) on a support structure for use in processing wires, for example, in operations to strip a wire end and crimp a ferrule onto a wire end. The ferrule reels typically include a roll of interconnected ferrules, which are wrapped around a drum of the ferrule reel between a set of reel flanges, typically made of cardboard (see, e.g., FIG. 4). The ferrule reels are typically in the form of standardized spools (e.g., an 8 mm ferrule spool, a 10 mm ferrule spool, etc.).

Conventional stripper-crimpers include a support structure for supporting the ferrule reels. However, certain support structures can reduce the reliability of the associated stripper-crimper, particularly when adapted for use in an automated process. In some cases, a support structure can cause interruptions in the processing of the wire ends, which can lead to required human interaction to correct the cause of the interruption, thereby slowing the automated processing of the wire ends. For example, operation of some conventional support structures on conventional stripper-crimpers can result in excess friction between the ferrule reel and the support structure. In some cases, the support structure lacks sufficient clearance between the ferrule reels and the support structure. In other cases, the support structure lacks the stiffness to accurately maintain the positioning of the ferrule reel relative to the stripper crimper. Further, as noted above, standard ferrule reels can include cardboard reel flanges, which are susceptible to expansion and contraction based on the environmental conditions (e.g., humidity, temperature, etc.). The expansion and contraction of the cardboard reel flanges can worsen the effects of friction between the support structure and the ferrule reels.

Other problems can also arise. For example, ferrule reels are statically supported by the support structure, in some cases at the drum of the ferrule reel, such that the ferrule reels can be maintained in a position relative to the stripper-crimper, yet rotate relative to the support structure. And the ferrule reels are not driven, but rather the roll of ferrules can be pulled, for example, by a transportation device on an automated machine. During unrolling of the roll of interconnected ferrules (e.g., by a transportation device) excess friction in conventional designs can increase the tension on the roll of interconnected ferrules, which can lead to a break in the roll.

Generally, the present disclosure provides an improved support structure for stripper-crimper machines or other machines that support similar reels. In particular, the present disclosure can provide systems and methods for a ferrule-reel mount including one or more ferrule reel support assemblies for supporting one or more ferrule reels on a stripper-crimper machine.

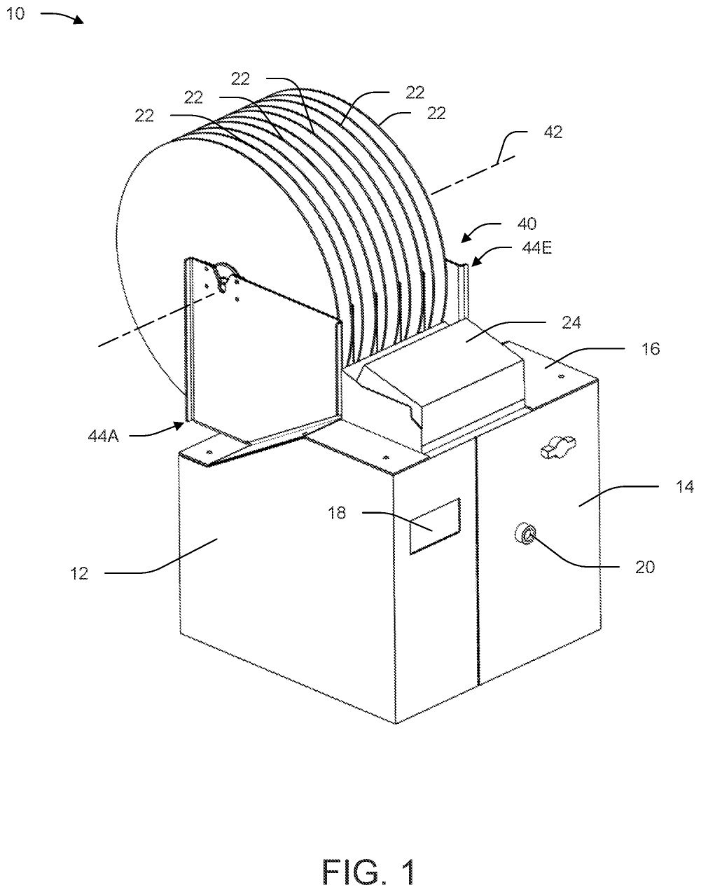

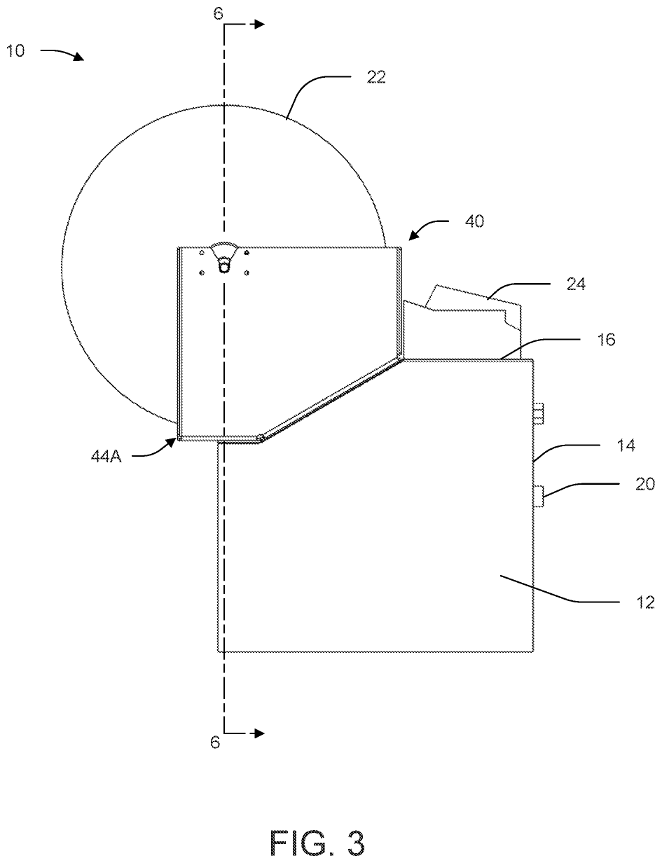

FIGS. 1 to 3 illustrate a stripper-crimper machine 10 configured to process one or more wire end ferrules, for example, by stripping a wire end and crimping a ferrule thereon. The stripper-crimper machine 10 includes a housing 12. The housing 12 can include an interface surface 14 and a support surface 16. The interface surface 14, in the illustrated example, is arranged on a front side of the housing 12 and can include a display 18 and a wire inlet 20. The display 18 can be configured as a touch screen display to allow a user to select between various machine settings, including selecting a desired wire size to be inserted into the wire inlet 20 (e.g., 12 awg, etc.), or as another interface (e.g., an LCD display). The wire inlet 20 is configured to receive a wire end therein for processing.

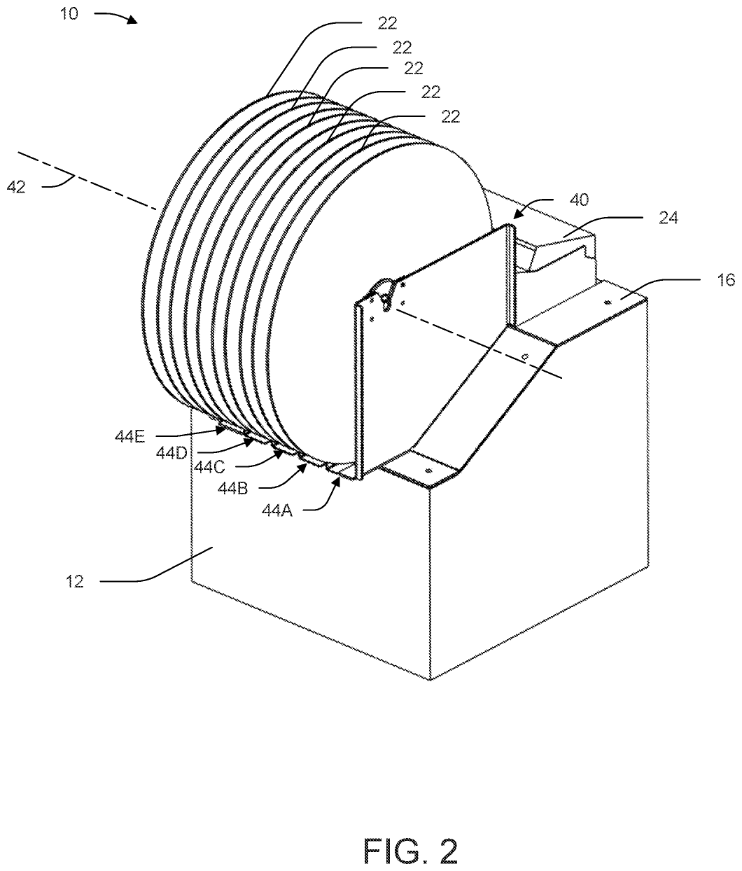

In the illustrated example, the support surface 16 is arranged on a top side of the housing 12 and is configured to support a transportation device and a ferrule reel mount 40. The transportation device 24 is configured to pull a roll of interconnected ferrules from the ferrule reels 22 supported by the ferrule reel mount 40 to provide ferrules into the housing 12 for processing. The ferrule reel mount 40 is configured to support one or more ferrule reels 22. In the illustrated example, the ferrule reel mount 40 is configured to support a plurality of ferrule reels 22. In the illustrated example, the ferrule reels 22 are supported by the ferrule reel mount 40 along a common axis 42. As best illustrated in FIG. 2, the ferrule reel mount 40 can include at least one ferrule support assembly 44 configured to be coupled to the housing 12 of the stripper-crimper machine 10 at the support surface 16. In the illustrated example, the ferrule reel mount 40 includes a plurality of ferrule support assemblies 44A through 44E, in which adjacent sets of the plurality of ferrule support assemblies 44A-44E define a space between support plates to receive a ferrule reel, and are configured to rotatably support a ferrule reel 22 within that space.

FIG. 4 illustrates an exploded view of the first ferrule support assembly 44A exploded along axis 42. Although the first ferrule support assembly 44A is illustrated, additional ferrule support assemblies 44B-44E are substantially identical to the first ferrule support assembly 44A, unless otherwise illustrated or described below. In the following description, only the first ferrule support assembly 44A will be described. This description may similarly apply to others of the ferrule support assemblies 44A through 44E in some cases (e.g., when the ferrule support assemblies 44A through 44E are generally identical).

As noted above, the ferrule support assembly 44A is configured to support a ferrule reel 22. The ferrule reel 22 can include a drum 50 defining a drum opening 52 extending axially through the drum, a first flange 54, and second flange 56. The drum 50 is arranged along (and for rotation about) axis 42 and is configured to support the first and second flanges 54, 56 thereon. The first and second flanges 54, 56 extend radially outward from the drum 50. As is known in the art, a roll of interconnected ferrules 58 can be wrapped around the drum 50 and received in the space between the axially opposing first and second flanges 54, 56.

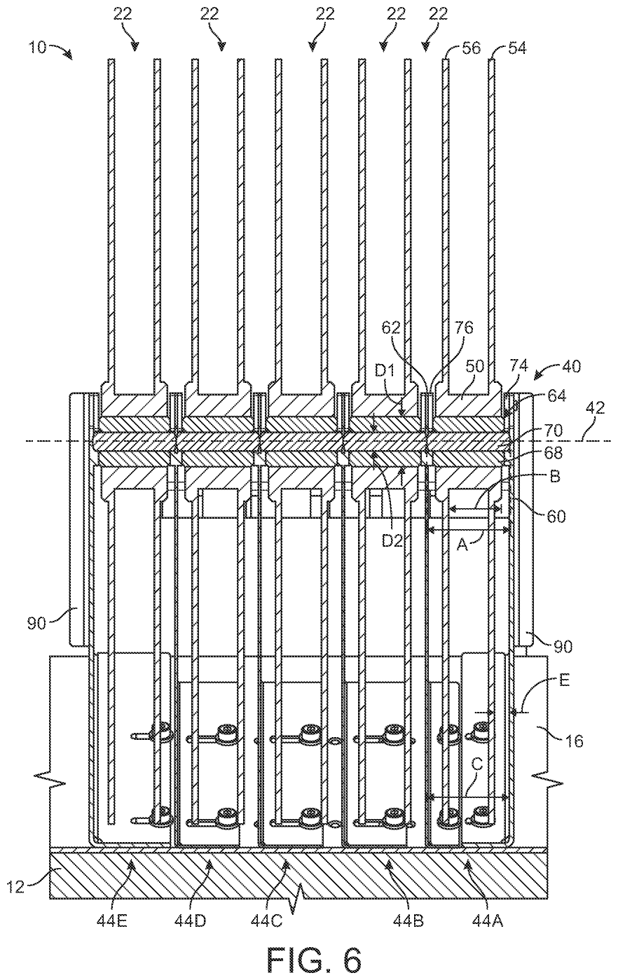

The ferrule support assembly 44A includes a first support plate 60, a second support plate 62, and an axle 64. The first support plate 60 is configured to be coupled to the stripper-crimper machine 10 at the support surface 16 (e.g., by one or more fasteners, see FIG. 6). The second support plate 62 is parallel to the first support plate 60 and arranged on an axially opposite side of the ferrule reel 22. In the illustrated example, the second support plate 62 is configured to be coupled to the stripper-crimper machine 10 at the support surface 16 (e.g., by one or more fasteners, see FIG. 6). According to some examples, the second support plate 62 can be integral to the first support plate 60. According to other examples, the second support plate 62 can be coupled to the first support plate 60 other than (or in addition to) being indirectly coupled via the support surface 16. Each of the first and second support plates 60, 62 include a respective axle notch 66A, 66B configured to receive and engage the axle 64 to support the axle 64 therein. In the illustrated example, the axle notches 66A, 66B in the first and second support plates 60, 62 are identical (i.e., are manufacture using the same specifications for dimensions and tolerances), although other configurations are possible.

The axle 64 is configured to be received within the drum opening 52 of the ferrule reel 22 and axially extend between the first and second support plates 60, 62 to support the ferrule reel 22 for rotation. In some cases, the axle 64 can include an axle shaft 68 and an axial protrusion 70 with a different diameter than the axle shaft 68. The axle shaft 68 is configured to be received within the drum 50 of the ferrule reel 22. In the illustrated example, the axle 64 is configured as a two-piece assembly, separately formed from the drum 50. Therefore, in an assembled configuration, the axial protrusion 70 is received within a shaft opening 72 of the axle shaft 68 such that the axial protrusion 70 extends beyond axially opposing ends of the axle shaft 68 to be received within the axle notches 66A, 66B of the first and second support plates 60, 62. According to some examples, the axle 64 can be a unitary component including the axle shaft 68 and the axial protrusion 70 as a one-piece assembly. In this configuration, the axial protrusion 70 can be configured as axle protrusions axially extending from opposing ends of the axle shaft 68.

In the illustrated example, the ferrule support assembly 44A further includes a first spacer 74 coupled to the first support plate 60 and a second spacer 76 coupled to the second support plate 62. The first spacer 74 is coupled to the first support plate 60 on a side facing the second support plate 62 and the second spacer 76 is coupled to the second support plate 62 on a side facing the first support plate 60. The first and second spacers 74, 76 are configured to provide an increased axial clearance between the ferrule reel 22 and the first and second support plates 60, 62. The increased axial clearance can help to prevent excessive friction between the ferrule reel 22 and the first and second support plates 60, 62, particularly for cases in which the flanges 54, 56 are non-parallel with each other (e.g., have deformed during use to splay axially outward). In the illustrated example, the first and second spacers 74, 76 are coupled to the first and second support plates 60, 62, respectively, with one or more fasteners (e.g., a rivet). According to some examples, the first and second spacers 74, 76 can be integrally formed into the respective first and second support plates 60, 62 as thickened portions of the plates 60, 62 or as other protruding features (e.g., as formed by bends in the plates 60, 62). As also discussed below, in the illustrated example, each of the first and second spacers 74, 76 include a respective notch 78A, 78B configured to receive and engage the axle 64 to support the axle 64 therein to facilitate rotation of the associated ferrule reel 22. In some cases, multiple spacers can be supported on a single support plate, including as may allow the spacers to facilitate rotation of ferrule reels on opposing sides of the support plate.

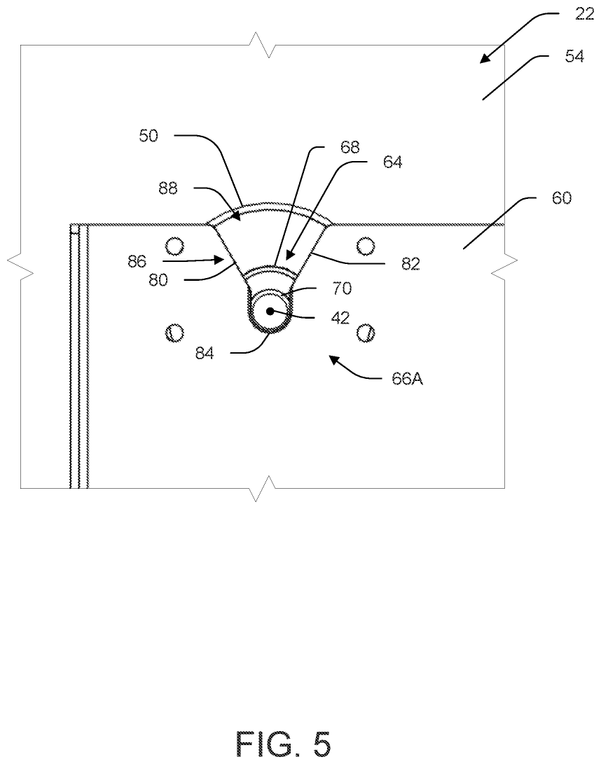

As best illustrated in FIG. 5, the axle notch 66A in the first support plate 60 can define an axle notch profile. The axle notch profile can include a first angled edge 80, a second angled edge 82, and a notch base 84. The first and second angled edges 80, 82 together form a guide portion 86 of the axle notch 66A that is configured to guide the axle 64 towards the notch base 84. The first and second angles edges 80, 82 of the guide portion 86 together form a notch opening 88 along a top edge of the first support plate 60. Further, the guide portion 86 is tapered from a perspective moving into the notch 66A, away from the opening 88. In particular, the first and second angles edges 80, 82 are angled relative to horizontal such that the guide portion 86 tapers inward from the notch opening 88 towards the notch base 84 of the axle notch 66A, such that a width of the guide portion 86 at the notch opening 88 is greater than a width of the notch base 84.

In the illustrated example, the notch base 84 defines a U-shaped slot connecting the first and second angled edges 80, 82 of the guide portion 86. As used herein, unless otherwise specified or limited, the term “U-shaped” specifies a shape that includes a base portion, with at least two leg portions extending in generally similar directions from the base portion. In some examples, a “U-shaped” slot can include leg portions extending from opposite ends of the base portion at substantially right angles to the base portion (i.e., deviating from right angles by less than 5 degrees), with or without curved, chamfered, or otherwise non-square connecting regions between the leg portions and the base portion. In some examples, a “U-shaped” slot can include leg portions that extend as part of a continuous (e.g., non-angled) curve from either end of a straight or curved base portion. Thus, for example, some “U-shaped” slots may have half-rectangular, semi-circular, or other similar slot profiles.” Further, some “U-shaped” slots may include a first leg that is longer than a second leg. In some cases, a base portion of a “U-shape” can extend over a circular segment. In the illustrated example, the notch base 84 defines a semicircular base portion of the “U-shaped” slot, with parallel leg portions extending from tangent edges of the semicircular base portion (e.g., on opposing sides of a horizontal diameter, as shown) to meet the first and second angled edges 80, 82 of the guide portion 86.

In some cases, a spacer can include a notch similar to (or instead of) a notch on a support plate. In some cases, a notch on a spacer can be aligned with a notch on a support plate so that the notches can collectively (e.g., simultaneously) support an axle for rotation. For example, as illustrated in FIGS. 4 and 5, each of the first and second spacers 74, 76 can include a notch 78A, 78B that aligns with the axle notch 66A, 66B of the first and second support plates 60, 62, respectively. As best illustrated in FIG. 5, the notches 78A, 78B in the first and second spacers 74, 76 can define a notch profile that matches the axle notch profile of the axle notch 66A, 66B of the first and second support plates 60, 62 (i.e., has a geometrically similar notch profile over at least a portion of the corresponding notch 66A, 66B that receives an axle for a ferrule reel). In some cases, the notch profiles of corresponding plate and spacer notches (e.g., notches 66A, 78A, or notches 66B, 78B) can be substantially identical to each other. In the illustrated example, that is, the notch 78A, 78B of the first and second spacers 74, 76 can include a corresponding first angled edge, second angled edge, and notch base, such that when the first and second spacers 74, 76 are installed onto the first and second support plates 60, 62, the edges of the notch 78A, 78B are flush with the edges of the axle notch 66A, 66B and can thereby provide an extended support surface for the axle 64.

Referring now to FIG. 6, the axle shaft 68 of the axle 64 can define a first diameter D1 and the axial protrusion 70 can define a second diameter D2. The first diameter D1 is dimensioned to be received within the drum opening 52 of the drum 50 such that the first diameter D1 is approximately the same as the diameter defined by the drum opening 52. In the illustrated example, the second diameter D2 is smaller than the first diameter D1. The axle 64 can also define an overall axial length A between opposing axial ends of the axle 64. In the illustrated example, the axial length A is greater than a width B defined by the drum 50 of the ferrule reel 22. As also shown in FIG. 6, a separate instance of the axles 64 is provided for each of the ferrule reels 22. In some cases, a single axle can support multiple ferrule reels.

With continued reference to FIG. 6, the first and second support plates 60, 62 can be axially separated by a gap C, which can be beneficial to provide clearance for the first and second flanges 54, 56 of the ferrule reel 22. The gap C can define a width of at least about 22 mm, or more. According to some examples, the gap C can define a width of between about 22 mm to about 45 mm. According to some examples, the gap C can define a width of between about 24 mm to about 40 mm. According to other examples, the gap C can define a width of between about 28 mm to about 38 mm. The gap C can provide sufficient axial distance between the first and second support plates 60, 62 to allow for an axial clearance E between flanges of the ferrule reel 22 and the adjacent support plates (e.g., between the first flange 54 and the first support plate 60) that is at least greater than about 1 mm. According to some examples, the axial clearance E be between flanges of the ferrule reel 22 and the adjacent support plates can be between about 1 mm and about 12 mm. According to some examples, the axial clearance E be between flanges of the ferrule reel 22 and the adjacent support plates can be between about 3 mm and about 9 mm.

According to the illustrated example, a set of adjacent ferrule support assemblies of the plurality of ferrule support assemblies 44A-44E can share a common support plate. That is, collectively, the plurality of ferrule support assemblies 44A-44E of the ferrule reel mount 40 form a plurality of support plates supported by the stripper-crimper machine 10. In the illustrated example, two adjacent ferrule reels 22 among the plurality of ferrule reels 22 are supported by a common support plate shared by adjacent sets of support plates. For example, either one of the first or second support plate of a first ferrule support assembly 44 can provide a first or second support plate for an adjacent second ferrule support assembly 44. In the illustrated example, the second support plate 62 of the first ferrule support assembly 44A is shared with the adjacent second support assembly 44B, which provides a first support plate for the second ferrule support assembly 44B (and likewise for assemblies 44B, 44C, assemblies 44C, 44D, and assemblies 44D, 44E).

In some cases, other features on a support assembly can also (or alternatively) help to generally facilitate smooth operation of a stripper-crimper. In the illustrated example, the axially outermost support plates among the plurality of ferrule support assemblies 44A-44E can include one or more peripheral side edges 90, 92 that are bent away from a plane perpendicular to an axis of rotation of a relevant ferrule reel (see also, FIG. 4). For example, the first support plate 60 of the first ferrule support assembly 44A includes side edge 90, 92 arranged on opposing sides of the first support plate 60 that are bent away from the ferrule reels 22. These bent edges can provide additional rigidity to the ferrule reel mount 40 and can also help to prevent edges of relevant ferrule reels from catching on the support plate 60 (e.g., after the cardboard flanges on the ferrule reel 22 have deformed outwardly from operational use).

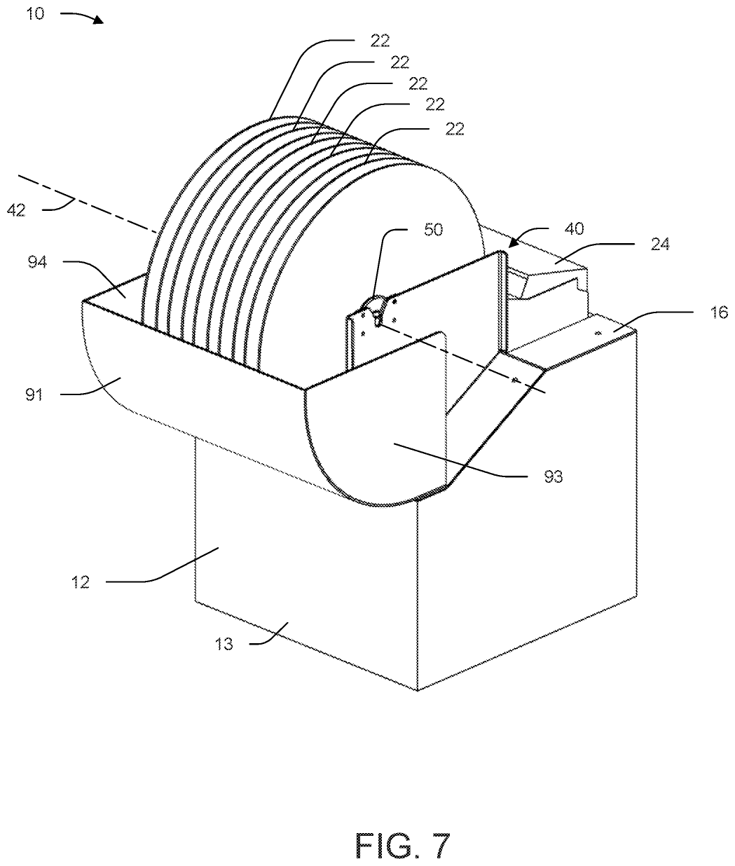

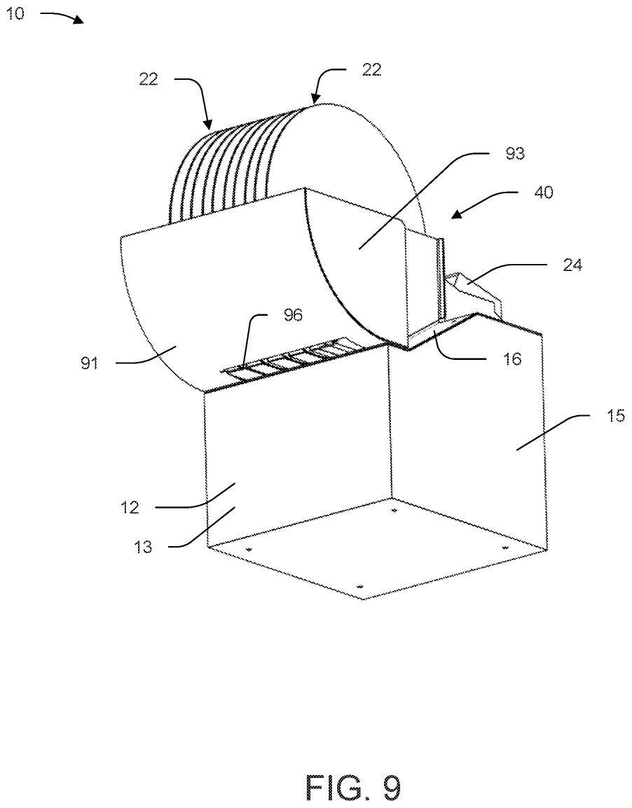

Referring now to FIGS. 7 to 9, the ferrule reel mount 40 can also include a curved support plate 91 configured to be coupled to the stripper-crimper machine 10 at the support surface 16 of the housing 12. The curved support plate 91 extends away from a back side 13 of the housing 12 to at least partially surround a peripheral edge of the ferrule reels 22. In the illustrated example, the curved support plate 91 extends rearward from the housing 12 to curve upwards about the axis 42 to partially surround the periphery of the flanges of the ferrule reels 22 (e.g., flanges 54, 56, see FIG. 6). In the illustrated example, the curved support plate 91 curves upwards to surround a quarter of the circumference of the ferrule reels 22, although other configurations are possible.

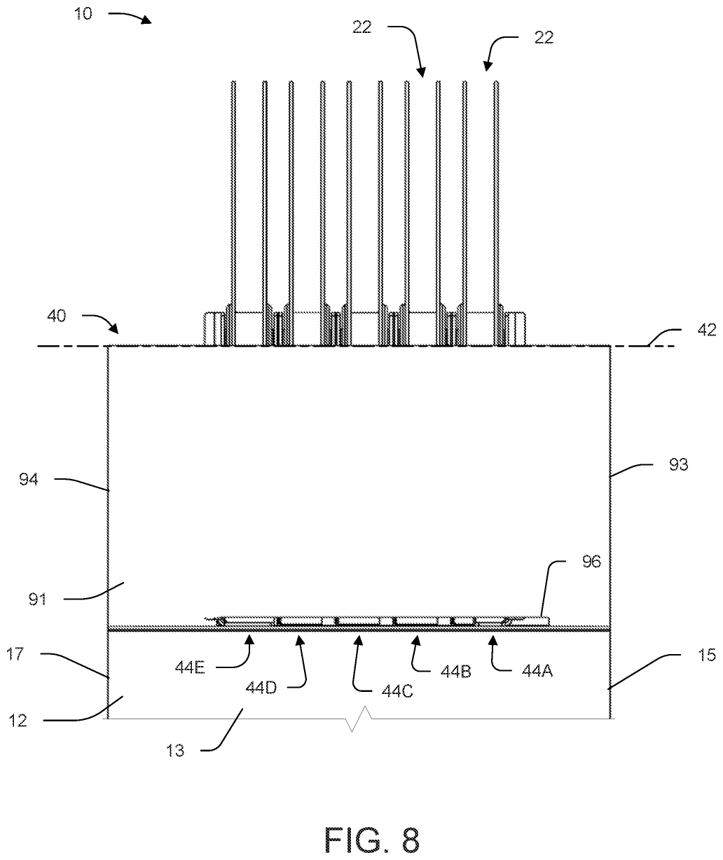

As best illustrated in FIG. 8, the curved support plate 91 axially spans a width of the stripper-crimper machine 10 to at least cover the plurality of ferrule reels 22 supported by the ferrule reel mount 40. In the illustrated example, the curved support plate 91 spans the entire width of the stripper-crimper machine 10 between opposing left and right sides 15, 17 of the stripper-crimper machine 10. As illustrated in FIGS. 7-9, the ferrule reel mount 40 can further include first and second end plates 93, 94 coupled to the opposing distal ends of the curved support plate 91 adjacent the left and right sides 15, 17 of the stripper-crimper machine 10. In the illustrated example, the curved support plate can include an opening 96 arranged adjacent to the bottom of the curved support plate 91 to receive at least a portion of the plurality of ferrule support assemblies 44A-44E. The curved support plate 91 can generally prevent the roll of interconnected ferrules wrapped on the drum 50 of the ferrule reel 22 from unravelling and falling outside of the ferrule reel 22 during operation of the stripper-crimper machine 10. The unravelling of the roll of ferrules can require further interaction by a user in order to correct the issue, which can slow the automated processing of wire ends.

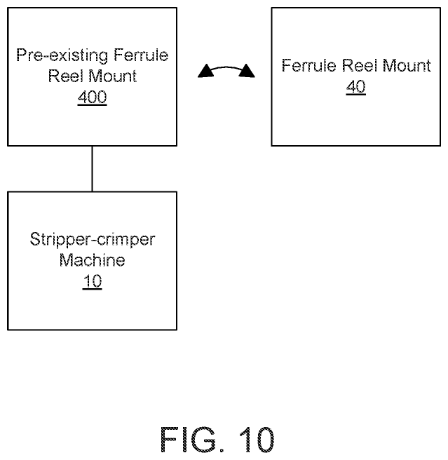

According to some examples, the ferrule reel mount 40 described above can be adapted, or retrofit onto a pre-existing stripper-crimper machine of various known configurations. As illustrated in FIG. 10, retrofitting a ferrule reel mount, such as the ferrule reel mount 40 described with respect to FIGS. 1-9, could be done by executing the following operations, which can in some cases be executed in different order than is presented below. In this context, pre-existing can refer to elements of a stripper-crimper machine that are installed by the original manufacturer, or elements that are made or provided by the original manufacturer of the stripper-crimper machine. The following description, where relevant, will make reference to the stripper-crimper machine 10 of FIGS. 1-9, although similar operations can be executed relative to other machines.

In one example, optionally, the ferrule reels 22 can first be removed from a pre-existing ferrule reel mount 400 (e.g., a first ferrule reel mount) of the stripper-crimper machine 10 (e.g., if the ferrule reels 22 were previously installed onto the pre-existing ferrule reel mount 400). Next, the pre-existing ferrule reel mount 400 can be removed from the stripper-crimper machine 10, for example, by the removal of one or more fasteners coupling the ferrule mount to the support surface 16 of the housing 12. Next, one or more ferrule support assemblies 44A-44E of the ferrule reel mount 40 (e.g., a second ferrule reel mount) can be installed onto the support surface 16 of the housing 12. For example, one or more ferrule support assemblies 44A-44E can be installed by one or more fasteners, including making use of the pre-existing fastener holes on the housing 12 of the stripper-crimper machine 10. Next, axles 64 can be inserted into one or more ferrule reels 22, and the ferrule reels 22 can be installed into a respective ferrule support assembly 44A-44E such that the ferrule reels 22 are supported by the ferrule reel mount 40 by the axle 64 within a respective axle notch (e.g., axle notches 66A, 66B of the first and second support plates 60, 62 of the first ferrule support assembly 44A). The stripper-crimper machine 10 can then be operated for relevant processing of wires, or otherwise, with the ferrule reels 22 beneficially supported by the ferrule reel mount 40.

The previous description of the disclosed embodiments is provided to enable any person skilled in the art to make or use the invention. Various modifications to these embodiments will be readily apparent to those skilled in the art, and the generic principles defined herein may be applied to other embodiments without departing from the spirit or scope of the invention. Thus, the invention is not intended to be limited to the embodiments shown herein but is to be accorded the widest scope consistent with the principles and novel features disclosed herein.

We claim:

1. A ferrule reel mount for supporting a plurality of ferrule reels on a stripper-crimper machine, the ferrule reel mount comprising:
a plurality of ferrule reels;
a plurality of support plates supported by a stripper-crimper machine; and
a plurality of axles that support the ferrule reels relative to the support plates, including an axle spanning between each set of adjacent support plates of the plurality of support plates,
wherein the axle is received within a drum of a ferrule reel of the plurality of ferrule reels to support the ferrule reel between the adjacent support plates;
wherein the ferrule reel and an adjacent ferrule reel among the plurality of ferrule reels are supported by a common one of the support plates.

2. The ferrule reel mount of claim 1, wherein, relative to an axial direction of the axle, an axial clearance between a reel flange extending radially outward from the drum of a ferrule reel of the plurality of ferrule reels and an adjacent support plate is between about 1 mm and about 12 mm.

3. The ferrule reel mount of claim 1, wherein, relative to an axial direction of the axle, the support plates of each of the sets of adjacent support plates are axially separated by a gap of greater than or equal to 22 mm.

4. The ferrule reel mount of claim 1, wherein the set of adjacent support plates includes:
a first support plate supported by the stripper-crimper machine; and
a second support plate supported by the stripper-crimper machine, and on an opposite side of a ferrule reel from the first support plate;
wherein each of the first support plate and the second support plate includes an axle notch configured to engage the axle extending between the first and second support plates.

5. The ferrule reel mount of claim 4, further comprising:
a first spacer coupled to the first support plate on a side of the first support plate that faces the second support plate; and
a second spacer coupled to the second support plate on a side of the second support plate that faces the first support plate;
wherein each of the first and second spacers includes a notch aligned with the axle notch of the first and second support plates, respectively; and
wherein each of the notches in the first and second spacers defines a notch profile that matches a profile of the axle notch in the corresponding first or second support plate.

6. The ferrule reel mount of claim 4, wherein the axle notch defines an axle notch profile that includes a guide portion and a base portion;
wherein the guide portion includes a first angled edge and a second angled edge arranged to guide the axle into the base portion of the axle notch; and
wherein the base portion includes a u-shaped slot connecting the first and second angled edges.

7. The ferrule reel mount of claim 1, wherein the axle defines an axial length that is greater than a width of the drum of the ferrule reel.

8. The ferrule reel mount of claim 1, wherein the axle includes an axle shaft and axle protrusions extending from opposing ends of the axle shaft; and
wherein the axle shaft defines a first diameter configured to be received within the drum of the corresponding ferrule reel, and the axle protrusions define a second diameter that is smaller than the first diameter.

9. A ferrule support assembly for a stripper-crimper machine, the ferrule support assembly comprising:
an axle configured to be received within a drum of a ferrule reel;
a first support plate configured to be coupled to the stripper-crimper machine; and
a second support plate configured to be coupled to the stripper-crimper machine, and spaced apart from the first support plate;
wherein the first support plate and the second support plate include an axle notch that receives and supports the axle, with the axle extending between the first and second support plates, for rotatable support of the drum via the axle.

10. The ferrule support assembly of claim 9, further comprising:
a first spacer coupled to the first support plate facing the second support plate; and
a second spacer coupled to the second support plate facing the first support plate.

11. The ferrule support assembly of claim 10, wherein each of the first and second spacers include a notch aligned with the axle notch of the first and second support plates, respectively; and
wherein each of the notches in the first and second spacers define a notch profile that is substantially identical to a profile of the axle notch in the corresponding first or second support plate.

12. The ferrule support assembly of claim 9, wherein the axle notch defines an axle notch profile that includes a guide portion and a base portion;
wherein the guide portion includes a first angled edge and a second angled edge configured to guide the axle into the base portion of the axle notch; and
wherein the base portion includes a u-shaped slot with side walls that extend from the first and second angled edges.

13. The ferrule support assembly of claim 9, wherein the first and second support plates are axially separated by a gap, the gap defining a width of greater than or equal to 22 mm, to receive the drum of the ferrule reel for rotational support via the axle.

14. The ferrule support assembly of claim 13, wherein the axle defines an axial length that is greater than a width of the drum of the ferrule reel.

15. The ferrule support assembly of claim 9, further comprising a curved support plate configured to be coupled to the stripper-crimper machine and extend from the stripper-crimper machine to at least partially surround a peripheral edge of the ferrule reel.

16. The ferrule support assembly of claim 9, wherein the axle includes an axle shaft having axle protrusions extending from opposing ends of the axle shaft; and
wherein the axle shaft defines a first diameter configured to be received within the drum of the ferrule reel, and the axle protrusions define a second, smaller diameter configured to be received within the axle notch of the first and second support plates.

17. The ferrule support assembly of claim 9, further comprising:
a plurality of support sub-assemblies, including a first support sub-assembly and one or more second support sub-assemblies;
wherein the first support sub-assembly includes the axle, the first support plate, and the second support plate,
wherein each of the one or more second support sub-assemblies includes, respectively, a sub-assembly axle, a sub-assembly first support plate, and a sub-assembly second support plate that are substantially identical to the axle, the first support plate, and the second support plate, respectively; and
wherein the support sub-assemblies are configured to be secured to the stripper-crimper machine to support a plurality of ferrule reels.

18. The ferrule support assembly of claim 17, wherein, for the first support sub-assembly and an adjacent support sub-assembly of the one or more second support sub-assemblies share a common support plate that forms one of the first support plate or the second support plate and one of the sub-assembly first support plate or the sub-assembly second support plate.

19. The ferrule support assembly of claim 17, wherein axially outermost support plates of the plurality of support sub-assemblies include one or more side edges that are bent away from the ferrule reel supported by the corresponding sub-assembly.

20. A method of retrofitting a ferrule reel support assembly on a stripper-crimper machine, the method comprising:
removing an installed first ferrule reel support assembly from a support surface of a housing of the stripper-crimper machine; and
installing a second ferrule reel support assembly onto the support surface of the stripper-crimper machine, the second ferrule reel support assembly including:
an axle configured to be received within a drum of a ferrule reel;
a first support plate configured to be coupled to the stripper-crimper machine; and
a second support plate configured to be coupled to the stripper-crimper machine opposite the ferrule reel from the first support plate;
wherein the first support plate and the second support plate include an axle notch configured to receive and support the axle, with the axle extending between the first and second support plates, to rotatably support the drum via the axle.
